(19) United States
(12) Patent Application Publication
(10) Pub. No.: US 2006/0224530 A1
(43) Pub. Date: Oct. 5, 2006

(54) Polycriteria transitivity process

(76) Inventors: Jeffrey L. Riggs, Gaithersburg, MD (US); Holland Coulter, Hendersonville, NC (US); Jennifer Lefeaux, Raleigh, NC (US)

Correspondence Address: HOFFMAN, WASSON & GITLER, P.C., 2461 South Clark Street, Crystal Center 2, Suite 522, Arlington, VA, 22202, US

(21) Appl. No.: 11/084,147

(22) Filed: Mar. 21, 2005

(51) Int. Cl. G06F 15/18

(52) U.S. Cl. 706/14

(57) ABSTRACT

A method for ordering pairwise value comparisons between members of a set, such as those comparisons made as part of the Analytic Hierarchy Process (AHP). The process enhances the overall consistency in the set of judgments by aiding the decision maker in coping with large judgment sets and by preserving the transitivity of the judgments. A matrix is created having entries relating to the value assigned to the pairwise comparisons.

### FIELD OF THE INVENTION

The present invention is directed to the field of decision making, wherein a visual matrix is produced containing values representing a comparison between a plurality of decision alternatives.

### BACKGROUND OF THE INVENTION

As part of the Analytic Hierarchy Process (AHP), a decision maker (individual or group) is asked to perform pairwise comparisons of elements within sets. The sets in which these comparisons are made are the set of decision alternatives and one or more sets of decision criteria. One of the strengths of the AHP is its tolerance for reasonable amounts of inconsistency that are expected with any human decision-making endeavor.

With each pair of elements, the decision maker must decide which is most preferred, and by how much it is preferred. The scale for these comparisons is the interval from 1 to some upper bound, usually 9. If the two elements being compared are felt to be equal in importance, the comparison is assigned the value 1, while the value 9 (or other upper bound) is assigned if the decision maker feels that one element is eminently more important (preferred) to the other. The intermediate values are used for less extreme preferences. AHP judgments are required to be reciprocal. If aᵢⱼ is the value of the preference given to element i over element j, then the preference for j over i, aⱼᵢ, must be 1/aᵢⱼ. The comparison of an element with itself, aᵢᵢ, is always 1.

The AHP uses these judgments of the relative values of the elements to derive an estimation of the underlying ratio scale of the value of the items. In the AHP, these weights are calculated by forming the matrix [aᵢⱼ] and its normalized principal right eigenvector w. The weight of element i is taken as wᵢ, the i^{th} component of the eigenvector. In general, the ratio of the weights of any two elements should be close to the original judgment regarding those two elements:
wᵢ/wⱼ≈aᵢⱼ
Equality will hold if and only if the set of judgments is completely consistent; that is, if for every i, j, k,
aᵢₖ=aᵢⱼ/aⱼₖ.
In this case, the principal eigenvalue will be n, the number of elements in the set, and all other eigenvalues will be 0. Small perturbations of a consistent matrix will produce a matrix with a dominant eigenvalue λₘₐₓ which is close to n and a principal eigenvector which is close to w. The implication is that reliable results can be obtained by the process even if the set of judgments is not perfectly consistent.

The questions is, how far from consistency can the set of judgments be? Human judgments almost never produce perfectly consistent results. When do the results of the process cease to inspire confidence? The AHP provides a measure of the amount of inconsistency in a set of judgments. The consistency index (CI) is defined by
CI=(λₘₐₓ−1)/(n−1).
The guideline is that the consistency index of a comparison matrix should not exceed a certain percentage of the consistency index of a “random” matrix of the same size—that is, of a reciprocal matrix of the same size whose entries were determined at random. These consistency indices for random matrices, called random indices (RI), have been determined experimentally for n≦15. In short, the consistency ratio, defined by CR=CI/RI, should not exceed a specified amount Lₙ. For n≧5, Lₙ=0.10. For n<5, L₄=0.08, and L₃=0.05. If n=2, there is only one judgment, and the matrix is consistent by definition.

Large comparison sets can provide significant interference with maintaining consistency in the judgments. In a set of n items, the decision maker must make (n²−n)/2 comparisons. This is rapid growth in terms of what the human mind can handle. Because of this, T. L. Saaty, the developer of AHP and author of Fundamentals of Decision Making and Priority Theory with the Analytic Hierechy Process, recommends that the size of the set of items to be compared not exceed seven or eight. These limits are based on the limits of the mind's ability to distinguish between differing amounts of physical quantities. When dealing with a set of more than seven or eight items, it becomes too difficult for the human mind to keep a grasp on the set of values as a whole. If a set must be larger, Saaty recommends clustering. This includes working one at a time with smaller subsets, chosen so that each subset has at least one member which is also a member of another subset. These ‘links’ between subsets provide a bridge for extending the judgment scale across the set as a whole.

In addition to these suggestions, which were built into the original formation of the AHP, other ways to assist in maintaining the consistency of judgment sets have been presented. Saaty himself has noted that a set of consistent comparison values can be deduced from a minimal set of judgments that form a spanning tree over the set of elements, so a decision maker can work with a larger set of comparison elements by not making all of the comparisons. A. Ishizaka and M. Lusti in “An Expert Module to Improve the Consistancy of ANP Matrices,” provide a guided method doing this by assisting the user in choosing a spanning subset. However, doing so reduces the consistency measure at the cost of working with less information. Evangelos Triantaphyllo in “Multi-Criteria Decision Making Methods: A Comparative Study” also provides a method for reducing the number of pairwise comparisons, by the formation of a duality model. P. T. Harker in “Alternative Modes of Questioning in the Analytic Hierarchy Process” provides a method for use when a general subset of the comparisons is not available.

All of these methods rely on reducing the number of comparisons. In everyday practice, most users make all of the comparisons in the decision set. Our objective here is to aid the process within this framework by presenting a simple method which enhances the participant's ability to make comparisons.

### BRIEF SUMMARY OF THE INVENTION

The shortcomings of the prior art are addressed by the present invention which is directed to a method of pairwise comparison of various alternatives or attributes to one another, regardless of the number of elements in the set of alternatives or attrributes. These pairwise comparisons produce a numerical output which is used to create a matrix. A relative relationship between the values in adjacent positions in the matrix is created. This order and matrix format enhance the consistency of the judgments by preserving transivity within the judgement set, while allowing users to make the full set of comparisons.

This and other objects of the present invention will be understood with reference to the drawings briefly described below.

### BRIEF DESCRIPTION OF THE SEVERAL VIEWS OF THE DRAWING

FIG. 1 represents a format for a matrix diagram according to the present invention;

FIG. 2 shows four beta sampling distributions according to the method of the present invention;

FIG. 3 illustrates a graph of binomial experiments of four simulation runs;

FIG. 4 illustrates the average CR for each of the simulations;

FIGS. 5A, 5B and 5C show the data used in the graphs shown in FIGS. 3, 4 and 5;

FIG. 6 is a list of criteria used to illustrate the method of the present invention; and

FIG. 7-13 illustrate various stages of the creation of a matrix, according to the present invention.

### DETAILED DESCRIPTION OF THE INVENTION

A necessary condition for consistency within the judgment set is transitivity of the comparisons. That is, if element i is preferred over element j and element j is preferred over element k, then element i should be preferred over element k. This condition is sometimes called ordinal transitivity, to distinguish it from cardinal transitivity, which describes the necessary and sufficient condition aᵢₖ=aᵢⱼ/aⱼₖ. Although necessary, ordinal transitivity (hereafter referred to simply as transitivity) is not a sufficient condition for consistency. Although transitivity is not required by the AHP, a set of transitive judgments is more likely to be within the acceptable inconsistency limits.

Consider a set of elements numbered 1, 2, . . . n and their pairwise comparisons aᵢⱼ, i,j≦n. Assume the elements are rank-ordered by preference, so that for i<j, element i is equally as important or preferred to element j. Generally, the first element of the set is considered to be the most preferred, the second is the second most preferred, and so on with the last element of the set being the least preferred. The set of elements can be arranged so that the first element is considered to be the least preferred and the last element is considered to be the most preferred. If a matrix would be constructed of all of the judgements, with the rows containing all of elements in rank order left to right, with the left most element being the most preferable and the columns being constructed in rank order from the top to the bottom, with the top element being the most preferable, it is clear that in this matrix, all of the judgments that exceed 1 will be above the main diagonal of the matrix, and their reciprocals will all be below the diagonal.

Let i<j<k≦n for all i,j,k. If this set of judgments is transitive then aᵢₖ≧aᵢⱼ and aᵢₖ≧aⱼₖ. In other words, if i is better than j, and j is better than k, then the preference for element i over element k should be at least as large as the preference for element i over element j. For any matrix entry above the main diagonal, its value should be less than or equal to the value of any entry to the right on the same row. Additionally, the preference for element i over element k should be as least as large as the preference for element j over element k: For any matrix entry above the main diagonal, its value should be bounded by the value of any entry above it in the same column.

Note that since judgments are bounded below by 1, aᵢₖ=1 constrains aᵢⱼ and aⱼₖ to the value 1 as well, which results in a value of 1 for each and every remaining entry in the method.

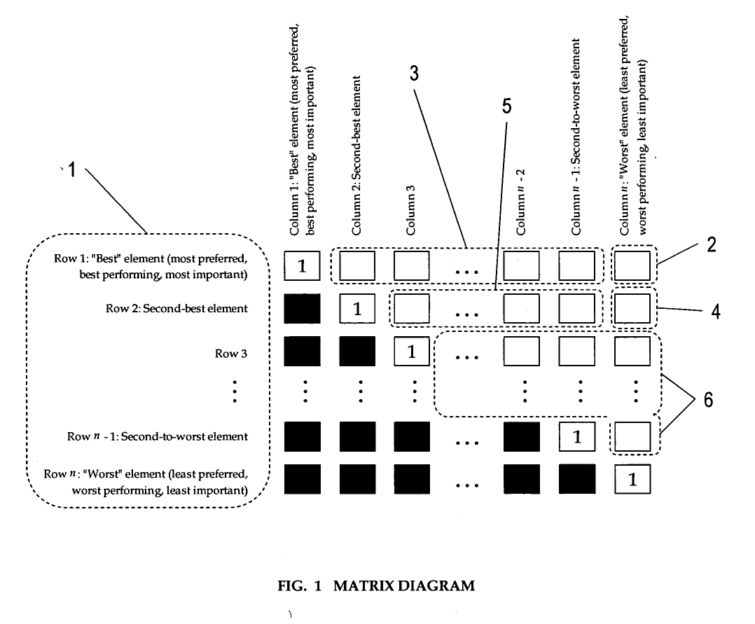

The steps of the Polycriteria Transitivity (PCT) method are illustrated in the partially completed matrix diagram illustrated in FIG. 1. This diagram presupposes comparing n elements to each other in pairwise fashion. The initial step of this pairwise comparison would be to rank the order of all of the n elements in the set to be compared. The most preferred or “best” element would be listed in the first row and the second most preferred element would be listed in the second row. The level of preference for the remaining elements of the set would be listed in descending order with the least preferred element appearing in row n. This is shown in box 1. Similarly, the columns of the matrix are labeled so that the left most column would list the most preferred element and the right most column would list the least preferred element. The elements included in the columns between the most preferred element and the least preferred element would include the remaining elements in descending order of preferability moving from left to right.

The next step would be to determine the value of a_{1,n} which would be inserted into box 2. This would be the value of a comparison between the most preferred element and the least preferred element. As previously indicated, all of the judgements between elements in the set would be made utilizing a numerical scale. For purposes of explanation, we would assume that the scale would be between 1 and 9, with 9 being the upper bound if the decision maker feels that the difference between elements 1 and n are greatly different. If two elements in the comparison are judged to be of equal importance, this judgement would then be assigned the value of 1. It is noted that a_{1,n} is the one matrix entry which neither has a top neighbor nor a neighbor to its right.

The next step in the method according to the present invention would be to make the remaining pairwise comparisons in the top row generally from right to left (a_{1,n-1}, a_{1,n-2}, . . . , a_{1,2}) making sure that each comparison value (i.e., 1-9) does not exceed the judgement value of its neighbor to the right. It is noted that neighboring values can be equal to one another. This is shown at reference numeral 3.

Once all of the judgement values in the top row have been determined and entered into their respective places in that row, the value of a_{2,n}, is determined at step 4. This step compares the second most preferred element of the set with the least preferred element of the set. It is noted that the value of a_{2,n} can be equal to but cannot exceed the value of a_{1,n}. Once this determination is made, the remaining judgements are made in the second row at step 5. These values are then inserted into their respective entry places in that row. As was true with respect to the top row, these additional value judgements are made moving from right to left, i.e. a_{2,n-1}, . . . , a_{2,3}. Similar to the entries in the top row, the judgement values in the second row must be less than or equal to the values of the entry to its right. Furthermore, it is important to note that the judgement value of each of the entries in the second row does not exceed, but can be equal to the judgement value immediately above it. In short, it must be insured that a_{2,i}≦min {a_{2,i+1}, a_{1,i}} for all iε{2, . . . , n}.

The process continues moving from right to left in each of the remaining rows, indicated at reference numeral 6, filling in the portion to the right of the diagonal from right to left. Each entry should be bounded by the value of the entry above it and by the value of the entry to the right, if one exists.

As shown in FIG. 1, the diagonal moving from the top left to the bottom right would always contain the numeral 1 because a comparison is made of each element to itself. Furthermore, it is noted it is not necessary to include the entries below the diagonal since these entries, which are the reciprocal of its mirror entries in the top half of the matrix, would not be necessary. Therefore, all of the squares below the diagonal are blackened.

With this method, transitivity is ensured even when making judgments about large sets of elements, and the limit on the size of the set can be extended beyond seven. It should be noted that this is not a mathematical “trick,” but is a particular presentation of the set of comparisons that allows the user to genuinely perceive and understand larger judgment sets. It separates the ordinal portion of the judgment making from the ratio portion. It is particularly helpful in group situations where consensus on the decisions is desired. Instead of having to cope with the entire judgment process at once, the group can first agree on the ordinal ranking of the elements, and then complete the transition to a ratio scale by agreeing on the values of the comparison judgments. Wedley, et al. demonstrated increased accuracy in perception of a physical phenomena, color, when decision makers were asked to make the first n−1 comparisons in a similar manner, as described in “Starting Rules for Incomplete Comparisons in the Analytic Hierarchy Process.”

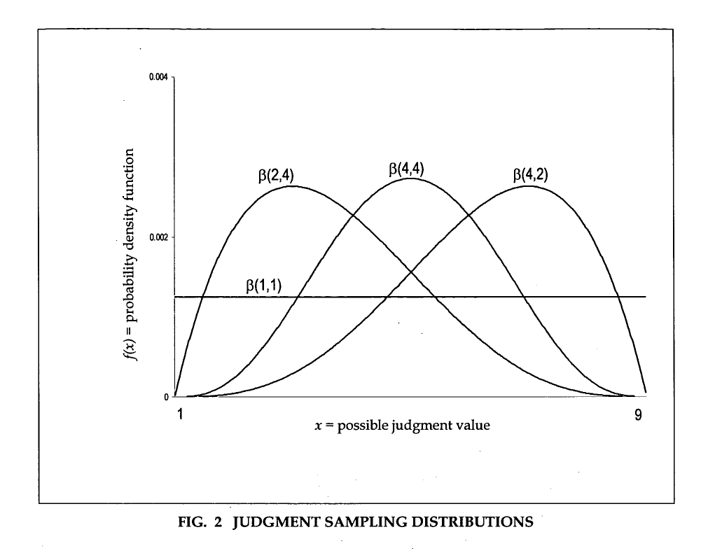

Monte Carlo simulations of transitive comparison matrices for n=3, 4, . . . , 15 were performed following the method of the present application. In the absence of real decision considerations, random comparison values were simulated on the interval (1, M), where M is the upper bound as outlined above for the comparison. This was accomplished by drawing a random number from a beta distribution β(α₁,α₂), scaling to the interval (0.5, M+0.5) and rounding this number to the nearest integer. Four simulations were run, using the four beta distributions shown in FIG. 2. These distributions included β(1,1), the uniform distribution, to simulate unbiased judgments from {1, 2, . . . , M}, as well as three others that might reasonably approximate a decision bias.

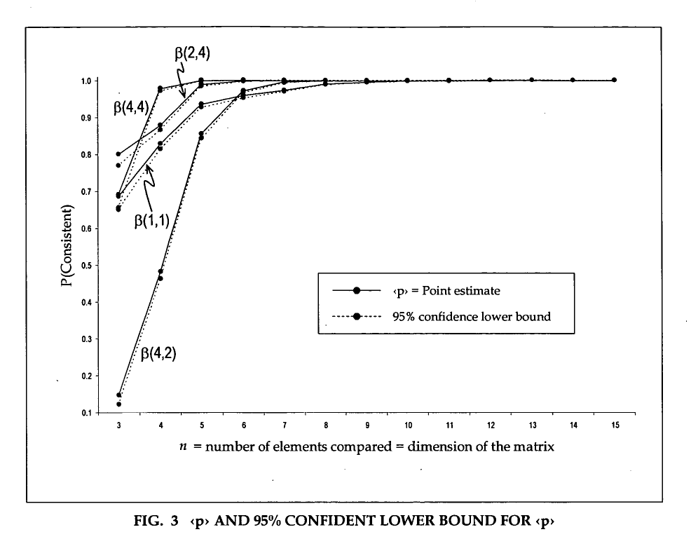

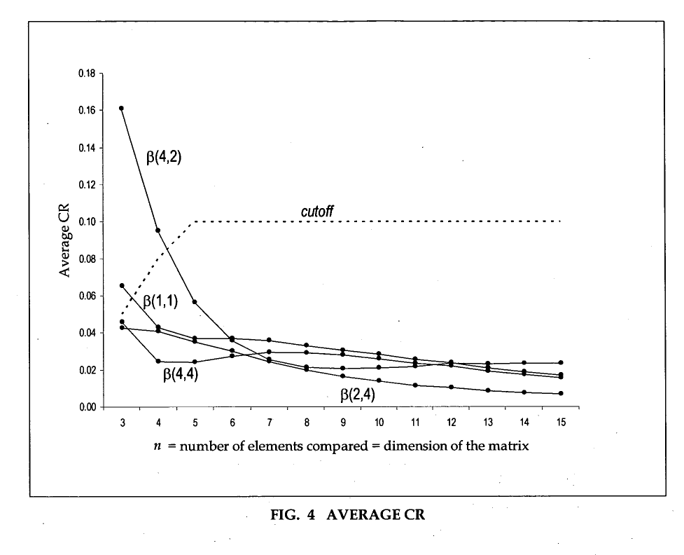

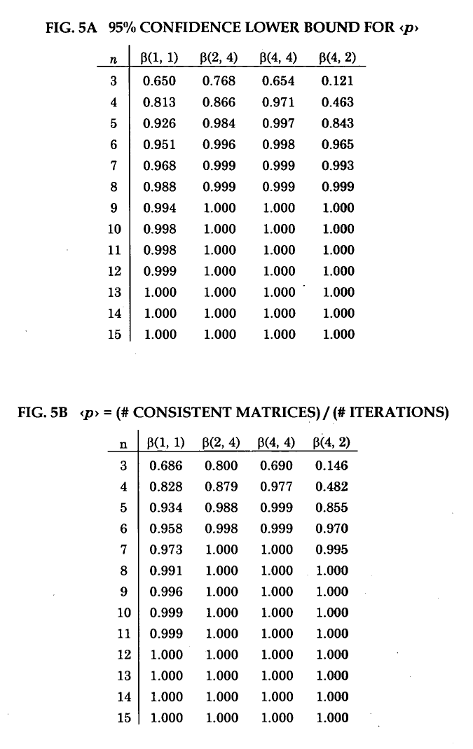

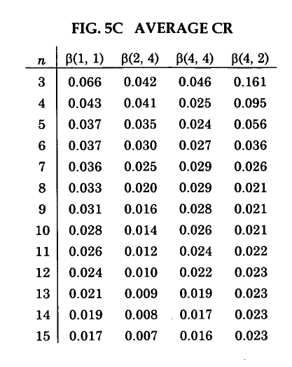

The results are shown in FIG. 3 and FIG. 4. The data for these charts is included in FIGS. 5A, 5B and 5C. FIG. 3 presents the simulations as binomial experiments in which a simulated matrix was considered a success if it was consistent (taken here to mean CR≦Lₙ) and a failure if CR>Lₙ. It shows the point estimates <p> for the parameter p, the probability that a matrix is consistent (<p> being the ratio of the number of consistent simulated matrices to the total number of generated matrices), and a 95% confidence estimate for a lower limit on the true value of p (computed using Leemis and Trivedi's exact method based on the F distribution as described in “A Comparison of Approximate Interval Estimators for the Bernoulli Parameter”). Each pair of curves is identified by the beta distribution that was used to sample the matrix entries. The point estimates <p> from a single simulation are connected with a solid line, and their corresponding lower bound estimates are connected with a dashed line. The values of the point estimates <p> are listed in FIG. 5B, and the lower bound estimates are listed in FIG. 5A. FIG. 4 shows the average CR for each simulation, along with the cutoff level Lₙ for each n. The data for FIG. 4 is listed in FIG. 5C.

From these results, it is clear that for n≧5, a transitive matrix has an excellent chance to be within the bounds of acceptable inconsistency. For a smaller n, transitivity alone does not provide a reasonable chance of being acceptably inconsistent. This seems clear because of the increased relative strengths of the judgments in such a small set: a smaller amount of comparisons maximizes the contribution of each decision to the consistency measure. This is not a cause for concern, since decision makers do not need assistance in making a set of a few consistent comparisons. As mentioned before, the procedure is of value as an aid to making comparisons within larger sets, and when consensus among group members is needed.

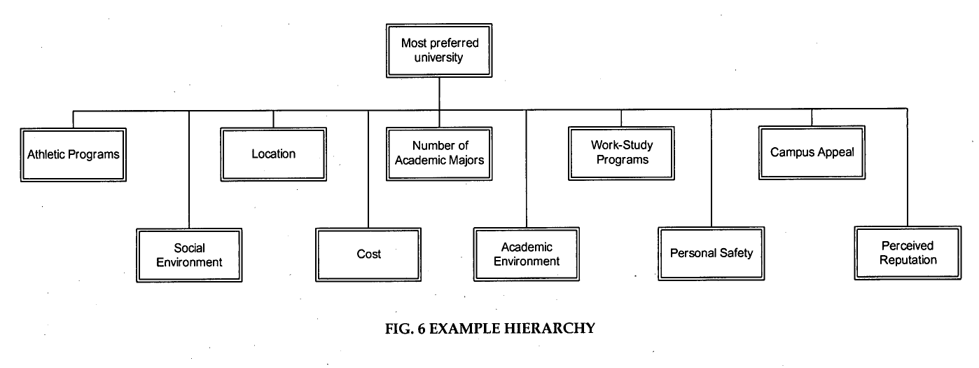

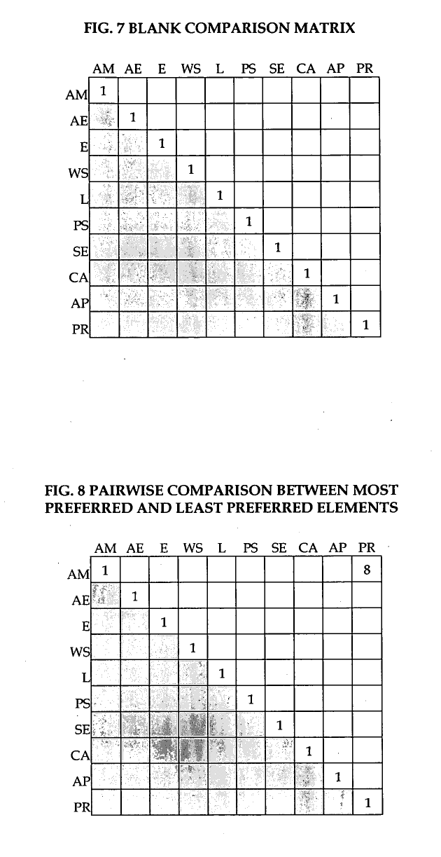

A simplified AHP selection problem is provided as an example. This particular example would illustrate the applicability of the teachings of the present invention to a decision which has to be made. In this example, a fictional student is choosing a university to attend. A set of ten criteria are posed and shown in FIG. 6. FIGS. 7-13 illustrate a matrix, formulated according to the method of the present invention in various stages of completeness.

As mentioned above, the first step of the process is to rank order the set of elements to be compared. For this example, suppose the student ranks the criteria as follows:

1. Number of Academic Majors (AM)

2. Academic Environment (AE)

3. Cost (C)

4. Work-Study Programs (WS)

5. Location (L)

6. Personal Safety (PS)

7. Social Environment (SE)

8. Campus Appeal (CA)

9. Athletic Programs (AP)

10. Perceived Reputation (PR)

The comparison matrix rows and columns are established according to the rank ordering of the criteria as shown in FIG. 7. Recall that all AHP comparison matrices are reciprocal and have is on the main diagonal. Due to the ordering of the criteria in the present invention and the reciprocity of the matrix, only the entries above the main diagonal need be completed.

The second step in the method is to make the pairwise comparison between the most preferred element and the least preferred element. In this example, this is the pairwise comparison between Number of Academic Majors and Perceived Reputation. A value of 8 has been assigned to this comparison as shown in FIG. 8.

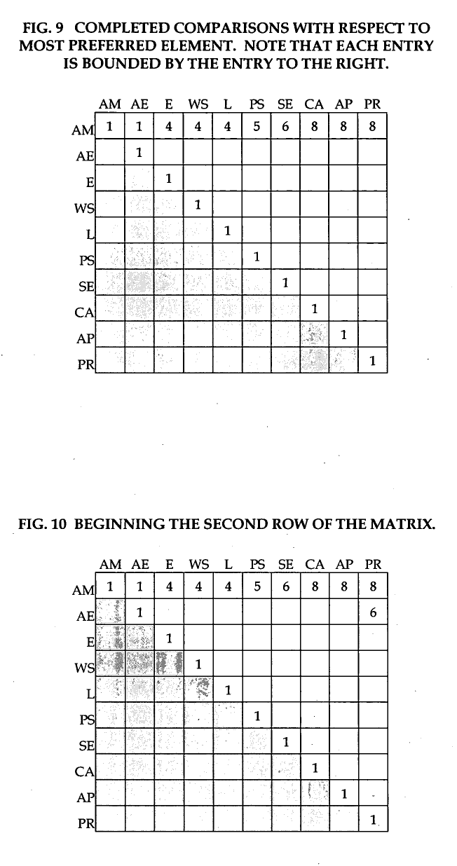

Since 8 is the largest value now possible for any of the remaining pairwise comparison values, none of the additional entries to the matrix can be larger than 8. The third step is to continue making all possible pairwise comparison with respect to the most preferred element as shown in FIG. 9. This completes the first row of the comparison matrix. The method requires that each judgment does not exceed the value of the previous judgment. This is also true for all subsequent rows.

To begin pairwise comparisons for the second row of the matrix, the second-most preferred element (Academic Environment) is compared to the least preferred element (Perceived Reputation) as shown in FIG. 10. This comparison value must be less than or equal to 8, the value in the preceding row, same column. In this example, we will assign the value of the comparison to be equal to 6.

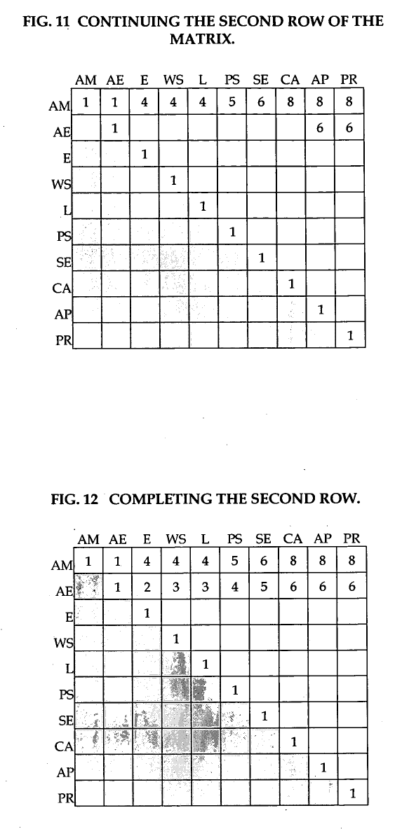

The second comparison in row 2 is between Academic Environment and the Number of Academic Majors. The value of this comparison must not exceed the value to the right or the value above. Therefore, it must not exceed min {8(the value above), 6 (the value to the right)}=6. The value of this comparison was also assigned to be 6, as shown in FIG. 11.

The second row of the comparison matrix is completed in the same manner. Again, each entry is bounded by the entry to the right and the entry above, is shown in FIG. 12.

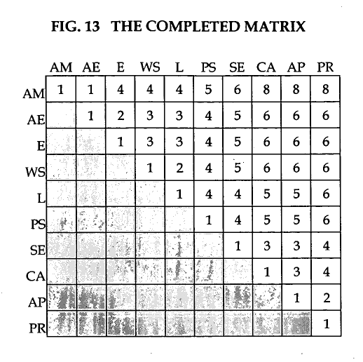

The remaining rows are completed similarly. All entries are bounded by the entry above and the entry to the right (if there is one), as shown in FIG. 13. The matrix yields the following results (using the geometric mean as an approximation to the right eigenvector) with a Consistency Ratio of 0.09.

| | |
|---|---|
| Number of Academic Majors | 0.27 |
| Academic Environment | 0.21 |
| Cost | 0.16 |
| Work-Study programs | 0.12 |
| Location | 0.09 |
| Personal Safety | 0.06 |
| Social Environment | 0.04 |
| Campus Appeal | 0.03 |
| Athletic Programs | 0.02 |
| Perceived Reputation | 0.02 |

In summary, the Polycriteria Transitivity (PCT) presentation of the set of comparisons allows the user to genuinely perceive and understand larger judgment sets by separating the ordinal portion of the judgment making from the ratio portion. Instead of having to cope with the entire judgment process at once, the ordinal ranking of the elements is done first, and then the transition to a ratio scale is completed by determining the values of the comparison judgments.

The foregoing is considered as illustrative only to the principles of the invention. Further, since numerous modifications and changes will be readily occur to those skilled in the art, it is not the desire to limit the invention to the exact construction and operation shown and described, and, accordingly, all suitable modifications and equivalents may be resorted to, falling within the scope of the invention. For example, the elements of the set can be illustrated in the matrix to proceed from the least preferable (along both the first column and the first row) to the most preferable (along both the last column and the lowest row). Additionally, the upper and lower bounds of the values of each comparison could run from 1 to representing the most difference between the elements of the set to the upper bound (for example 9) being the least difference. Furthermore, it would be possible to formulate a matrix in which only the lower portion of the matrix below the main diagonal extending from the top left to the bottom right entries would be completed. In this instance, the upper portion of the matrix above the diagonal would be left blank. Alternatively, a matrix can be formulated when the main diagonal would extend from the lower left of the matrix to the top right of the matrix.

What is claimed:

1. A method of ranking and illustrating pairwise comparisons between all of the elements in a set of n elements, comprising the steps of:
a) ranking the order of each of the n elements, from the most preferred element to the least preferred element;
b) creating an n×n matrix utilizing n row headings, listing said n elements from top to bottom extending from the most preferred element to the least preferred element, said n×n matrix also including n column headings listing said n elements, extending from the most preferred element to the least preferred element, said matrix including a diagonal extending from the top left corner of said matrix to the bottom right corner of said matrix, said diagonal dividing said matrix into a top half and a bottom half;
c) pairwise comparing said most preferred element to said least preferred element;
d) assigning a value of the comparison in step c) utilizing a numeric scale extending from a first limit to a second limit;
e) inserting said value assigned in step d) into the appropriate entry of said n×n matrix;
f) pairwise comparing said most preferred element to the remaining elements;
g) assigning a value between said first and second limit for each of said comparisons in step f);
h) inserting each of said values determined in step f) into the appropriate matrix entry of said matrix, ensuring that each of said values has the appropriate numeric relationship with its neighboring entries, each of said entries being made in said top half of said matrix, thereby completing a row of said matrix;
i) making a pairwise comparison between all of said elements in the next row of said matrix;
j) assigning a value between said first and second limit for each of said pairwise comparisons in step i);
k) inserting each of said values into the appropriate matrix entry of the next row of said matrix, ensuring that each of said values has the appropriate relationship with its neighboring entries, each of said entries being made in said top half of said matrix; and
l) repeating steps i), j), and k) until all of the entries are made in said top half of said matrix.

2. The method in accordance with claim 1, wherein each of said matrix entries is an integer.

3. The method in accordance with claim 1, wherein said value of each of the diagonal entries is said first limit.

4. The method in accordance with claim 1, wherein n≧7.

5. The method in accordance with claim 3, wherein said first limit is said lower limit and is equal to 1.

6. The method in accordance with claim 1, wherein said n row headings extend from said most preferred element at the top of said matrix to said least preferred element at the bottom of said matrix, and further wherein said n column headings extend from said most preferred element at the left side of said matrix to said least preferred element at the right side of said matrix.

7. The method in accordance with claim 6, wherein said values in step h) inserted into said matrix is less than or equal to the value to its right in said matrix.

8. The method in accordance with claim 7, wherein each of said values in step k) inserted into said matrix is less than or equal to the value to its right and less than or equal to the value above it in said matrix.

9. The method in accordance with claim 1, wherein said first limit has a greater value than second limit.

10. The method in accordance with claim 9, wherein said n row headings extend from said most preferred element at the top of said matrix to said least preferred element at the bottom of said matrix, and further wherein said n column headings extend from said most preferred element at the left side of said matrix to said least preferred element at the right side of said matrix.

11. The method in accordance with claim 10, wherein said values of step h) inserted into said matrix is greater than or equal to the value to the right in said matrix.

12. The method in accordance with claim 11, wherein each of said values in step k) inserted into said matrix is greater than or equal to the value to its right and greater than aor equal to the value above it in said matrix.

13. The method in accordance with claim 12, wherein each of the values inserted into said diagonal is said first limit.

14. A method of ranking and illustrating pairwise comparisons between all of the elements in a set of n elements, comprising the steps of:
a) ranking the order of each of the n elements, from the least preferred element to the most preferred element;
b) creating an n×n matrix utilizing n row headings, listing said n elements from top to bottom extending from the least preferred element to the most preferred element, said n×n matrix also including n column headings listing said n elements, extending from the least preferred element to the most preferred element, said matrix including a diagonal extending from the top left corner of said matrix to the bottom right corner of said matrix, said diagonal dividing said matrix into a top half and a bottom half;
c) pairwise comparing said least preferred element to said most preferred element;
d) assigning a value of the comparison in step c) utilizing a numeric scale extending from a first limit to a second limit;
e) inserting said value assigned in step d) into the appropriate entry of said n×n matrix;
f) pairwise comparing said least preferred element to the remaining elements;
g) assigning a value between said first and second limit for each of said comparisons in step f);
h) inserting each of said values determined in step f) into the appropriate matrix entry of said matrix, ensuring that each of said values has the appropriate numeric relationship with its neighboring entries, each of said entries being made in said top half of said matrix;
i) making a pairwise comparison between all of said elements in the next row of said matrix, thereby completing a row of said matrix;
j) assigning a value between said first and second limit for each of said pairwise comparisons in step i);
k) inserting each of said values into the appropriate matrix entry of the next row of said matrix, ensuring that each of said values has the appropriate relationship with its neighboring entries, each of said entries being made in said top half of said matrix; and
l) repeating steps i), j), and k) until all of the entries are made in said top half of said matrix.

15. The method in accordance with claim 9, wherein each of said matrix entries is an integer.

16. The method in accordance with claim 9, wherein said value of each of the diagonal entries is said first limit.

17. The method in accordance with claim 1, wherein n≧7.

18. The method in accordance with claim 16, wherein said first limit is a lower limit equal to 1.

19. The method in accordance with claim 14, wherein said n row headings extend from said least preferred element at the top of said matrix to said most preferred element at the bottom of said matrix, and further wherein said n column headings extend from said least preferred element and the left side of said matrix to said most preferred element at the right side of said matrix.

20. The method in accordance with claim 19, wherein each of said values in step h) inserted into said matrix is less than or equal to the value to its right in said matrix.

21. The method in accordance with claim 20, wherein each of said values in step k) inserted into said matrix is less than an equal the value to its right and less than or equal to the value above it in said matrix.

22. The method in accordance with claim 18, wherein said n row headings extend from said least preferred element at the top of said matrix to said most preferred element at the bottom of said matrix, and further wherein said n column headings extend from said least preferred element and the left side of said matrix to said most preferred element at the right side of said matrix.

23. The method in accordance to claim 19, wherein each of said values in step h) inserted into said matrix is greater than or equal to the value to its right in said matrix.

24. The method in accordance with claim 23, wherein each of said values in step k), inserted into said matrix is greater than or equal to the value to its right and less than or equal to its value above and in said matrix.
